(19) United States
(12) Patent Application Publication
(10) Pub. No.: US 2017/0021917 A1
(43) Pub. Date: Jan. 26, 2017

(54) AERODYNAMICALLY ORIENTED THERMAL PROTECTION SYSTEM OF HYPERSONIC VEHICLES

(71) Applicant: NIKOLAOS KEHAYAS, KIFISSIA (GR)

(72) Inventor: NIKOLAOS KEHAYAS, KIFISSIA (GR)

(21) Appl. No.: 15/091,268

(22) Filed: Apr. 5, 2016

Related U.S. Application Data
(60) Provisional application No. 62/146,254, filed on Apr. 11, 2015.

(51) Int. Cl. B64C 23/04; B64G 1/62; B64C 1/38; B64C 30/00

(52) U.S. Cl. CPC B64C 23/04; B64C 30/00; B64G 1/62; B64C 1/38

(57) ABSTRACT

Aerodynamically oriented thermal protection system (TPS) for hypersonic aerospace vehicles which is based on a suitable spike—forebody configuration. The conical forebody semi-angle is much smaller than the cone-shaped spike tip semi-angle. As a result a separated recirculating flow is established in the region after the spike tip and a series of expansion waves are formed near the forebody—main body intersection. The separated recirculating flow shields the forebody from heat following the shock wave, and the expansion waves prevent high temperatures in the area of the forebody—main body intersection and beyond. Due to the spike tip large shock wave angle the whole of the aerospace vehicle lies within the spike tip shock wave cone and, thus, shock wave—shock wave interactions are avoided. The proposed spike—forebody configuration substantially reduces aerodynamic heating and, therefore, a conventional TPS with the associated mass penalty, and safety, reliability, maintenance and cost drawbacks is avoided.

I claim the benefit of Provisional Application No. 62/146,254 filed on 11 Apr. 2015 and entitled “Aerodynamically Oriented Thermal Protection System of Hypersonic Vehicles”.

### TECHNICAL FIELD

The present disclosure generally relates to an aerodynamically oriented thermal protection system (TPS) of aerospace vehicles, travelling through or entering the atmosphere at very high Mach numbers, through the use of an appropriate spike—forebody configuration.

### BACKGROUND

High-speed aerodynamic heating is a major issue in aerospace vehicle design. Hypersonic aerospace vehicles traveling through the atmosphere experience high Mach numbers. In particular, vehicles re-entering the atmosphere at orbiting velocities reach Mach numbers of at least 25. Flows at these Mach numbers result in very high vehicle surface temperatures due to air friction. Space Shuttle's wing leading edges, for example, reach temperatures of up to 1200 K.

Re-entry aerodynamic heating is addressed with aerodynamic means, TPS, heat-resistant materials and a suitable flight path. The aerodynamic approach includes blunt bodies and spikes. It was recognized in the 1950s that heat transfer rate can be minimized by high-drag blunt bodies dissipating a large part of the kinetic energy of the body, with a detached bow shock, as heat in the surrounding air. Since, the blunt body concept has been adopted for all re-entry drones, capsules or vehicles. Spikes, as a way of alleviating the effect of re-entry heating have been suggested even earlier. The spike is a pointed thin cylindrical rod projected in the upstream direction, at the stagnation point of a blunt forebody. It provoques the separation of the boundary layer from its surface and the establishment of a shear layer which reattaches on the blunt forebody surface. Between the spike, the shear layer and the blunt forebody a recirculation zone of low pressures and velocities is created. This zone screens a substantial portion of the blunt forebody and results in significant drop in surface pressure and temperature. At the shear layer reattachment region a shock wave is developed at the blunt forebody shoulder. Immediately downstream of the reattachment position the flow pressure and temperature reach very high values. The total effect is a considerable reduction in aerodynamic heating and drag as indicated from the earliest experimental studies. It should be noted that the influence of a spike on the heat transfer rate in hypersonic flow very much depends on whether the separated boundary layer is laminar or turbulent. Spikes in the form of energy injection by jet, projectile or laser beam have also been considered. Although spikes show promise in heat and drag reduction they have not been extensively exploited to this day.

The problem of re-entry heating has not been completely solved aerodynamically. For this reason, in addition to appropriate aerodynamic design, a TPS is needed to cope with the very high surface temperatures. There are three types of TPS: heat sinks, radiative cooling and mass transfer. In heat sinks heat is directed and stored in extra material carried along the vehicle for this purpose. It is a simple and effective but very heavy solution. It has been used in early Intercontinental Ballistic Missiles (ICBM). The mass transfer option for a TPS includes internal active cooling, transpiration cooling and ablation. In active cooling fluid is pumped under the surfaces that experience re-entry heating. In transpiration cooling cool fluid runs through pores of the heated surface. The fluid absorbs heat by convection and thus cools down the surface. But for both concepts the associated mass penalty is prohibitive. Ablation TPS take advantage of the latent heat of the surface material. The vehicle's surface is made or coated with a material having a very high latent heat of fusion. As this material melts or vaporizes during re-entry it absorbs large amounts of heat and hence protects the vehicle. Ablation TPS have been used on some ICBM and on all manned and unmanned return capsules. The disadvantage of ablation is that the return vehicle is partially destroyed, and to be used again major refurbishment is required.

If an object absorbs enough heat, it warms up and, at the same time radiates some of the heat through radiative emission. The process continues until the energy emitted balances the energy absorbed at which point it reaches a thermal equilibrium and from then on its temperature stays constant. The placement of a coating with high emissivity on top of an insulating material above the vehicle's surface is how re-entry heating is currently dealt, as exemplified by Space Shuttle's tiles. Although this type of TPS is much lighter than heat sinks and mass transfer, and reusable in contrast to ablative coating, it still represents a substantial proportion of the vehicle's mass. Space Shuttle TPS, in the shape of ceramic tiles, represents nearly 9.5% of its landing mass.

In addressing re-entry heating complimentary to aerodynamic means and TPS are suitable materials and an appropriate flight profile. Among the heat-resistant, high-strength materials are metal matrix alloys, carbon-carbon composites, refractory composites and high conductivity composites. Flight profile is another tool for alleviating re-entry heating. Using lift the vehicle's re-entry is less steep and deceleration takes place at a higher altitude where the atmosphere is much less dense. In this way heat rates, and in turn vehicle surface temperatures, are lower.

However, despite all these advances in technology, techniques and practices, a reliable and sound solution to the re-entry and generally high-speed, aerodynamic heating has not been found.

### SUMMARY OF THE INVENTION

This invention relates to an aerodynamically oriented TPS for hypersonic aerospace vehicles. It is based on a suitable spike-forebody configuration. The spike is projecting upstream from the stagnation point of the vehicle forebody and produces a shock wave. The spike has a rod-like body and a tip in the shape of a cone. The vehicle forebody has the form of a conical body. The semi-angle of cone-shaped spike tip has the maximum value corresponding to an attached shock wave.

Because the semi-angle of the conical forebody is made to be much smaller than the semi-angle of the cone-shaped spike tip, a series of expansion waves are formed near the forebody—main body intersection. After the spike tip and between the spike tip shock wave, the spike rod and the forebody a region of separated recirculating flow is established bounded on the shock wave side by a shear layer and by the series of expansion waves near the forebody—main body intersection. The separated recirculating flow serves to shield the forebody from the intense heat produced by the spike tip shock wave. The expansion waves near the forebody—main body intersection substantially reduce the very high heat rates and the resulting very high temperatures in the area.

Heat absorbed by the spike tip is conveyed by the spike rod to the surrounding relatively cooler separated recirculating flow. The spike tip is made as small as it is necessary to produce an attached shock wave. The spike tip could be replaced after each mission. Due to the small size of the spike tip shock wave—boundary layer interaction at the tip is minimal and, hence, the spike tip shock wave is mildly curved. As a consequence, heat resulting from the spike tip shock wave is dissipated over a much wider area and away from the vehicle.

Furthermore, as the semi-angle of the cone-shaped tip is large and, therefore, the wave angle of the shock wave produced is respectively large, the tip shock wave does not meet the shock wave of the wing, tail or other protruding parts of the vehicle. Thus, a shock wave—shock wave interaction and its adverse effects on flow pressure and temperature levels does not take place. The whole of the aerospace vehicle lies within the cone of the shock wave produced by the spike tip.

Overall, the proposed spike-forebody configuration substantially reduces aerodynamic heating effects. As a result, a conventional TPS with the associated mass penalty, and safety, cost, reliability and maintenance drawbacks is avoided.

### BRIEF DESCRIPTION OF THE DRAWINGS

The present invention will be more fully understood by the following description and the accompanying drawings which are given by way of illustration and thus are not limitative and wherein:

FIG. 1 shows a schematic view of the rod-like spike with a tip in the shape of a cone, the conical forebody of the aerospace vehicle and the cone-shaped tip and conical forebody semi-angles.

FIG. 2 shows in a schematic way the cone-shaped spike tip shock wave, the separated recirculating flow after the spike tip, the shear layer between the spike rod and the spike shock wave and the series of the expansion waves near the forebody-main body intersection.

FIGS. 3 and 4 show in a schematic way the whole of the aerospace vehicle lying within the cone of the shock wave produced by the spike tip.

### DETAILED DESCRIPTION OF THE INVENTION

The following detailed description of the invention is merely exemplary in nature and is not intended to limit the described embodiments or the application and uses of the embodiments.

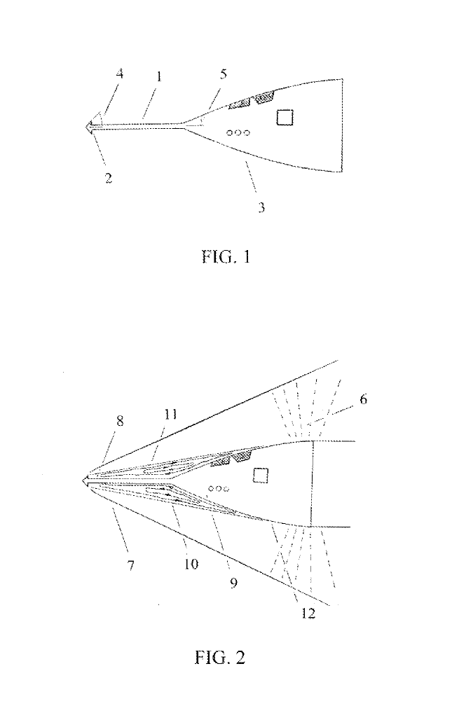

Aerospace vehicles travelling through or entering the atmosphere at very high Mach numbers may use spikes to reduce aerodynamic heating. The proposed aerodynamically oriented TPS is based on a suitable vehicle spike—forebody configuration. As depicted in FIG. 1 the spike body is a cylindrical rod 1 projecting from the stagnation point of the vehicle forebody and facing upstream with a spike tip in the shape of a cone 2. The base diameter of the cone-shaped tip is larger than the diameter of the spike body cylindrical rod. As depicted in FIG. 1 the vehicle forebody has the form of a conical body 3 which can have the shape of a cone or an ogive. The spike tip produces a shock wave. The semi-angle of the cone-shaped spike tip 4 has the maximum value corresponding to an attached shock wave. As the maximum value of the semi-angle of a cone in high-speed flow leading to an attached shock wave is a function of Mach number, a spike cone-shaped tip semi-angle value corresponding to Mach number 3 is selected. In this way it is assured that a shock wave which is attached to the cone-shaped spike tip is produced for flows at Mach numbers over 3, a flow regime for which aerodynamic heating becomes of importance and, therefore, a TPS is needed. As depicted in FIG. 1, the semi-angle of the conical forebody 5 is much smaller than the cone-shaped spike tip semi-angle 4. As a result, as depicted in FIG. 2, using a spike of appropriate length, a series of expansion waves 6 are formed near the forebody—main body intersection. As depicted in FIG. 2, after the spike tip and between the spike tip shock wave 7, the spike rod-like body 8 and the vehicle forebody 9, a region of separated recirculating flow is established 10 bounded on the shock side by a shear layer 11 and by the series of expansion waves 6 near the forebody—main body intersection. The spike length is such that the dividing streamline of the shear layer meets the body near the forebody—main body intersection point 12. The presence of the separated recirculating flow serves to shield the front part of the conical forebody from the intense heat developed by the spike tip shock wave. The presence of expansion waves near the forebody—main body intersection substantially reduces the very high heat rate and the resulting very high temperatures in the area.

Merely exemplary and not intended to limit the described embodiments or the application and uses of the embodiments the described spike-forebody configuration leads to the development of the flow and the flow temperatures in the area as follows: The maximum value of cone semi-angle resulting in an attached shock wave at Mach number 3 and above is close to 48°. At Mach number 25, a typical value of re-entry from LEO, an atmospheric air temperature of 220 K and taking into account the ratio of heat capacities for a chemically reacting gas, a cone-shaped spike tip with a semi-angle of 48° produces a shock wave with a shock angle near to 53° which corresponds to a Mach number and temperature behind the shock wave of around 3 and 5500 K respectively. Subsequently, the flow goes through the series of expansion waves near the forebody—main body intersection. Assuming a conical forebody semi-angle of, say, 15°, a flow turning angle of 38° is formed, giving a Mach number and temperature behind the expansion waves of around 6.6 and 1950 K respectively. A flow temperature of 1950 K would result in a vehicle surface temperature, assuming non-catalytic conditions at the surface, of about 650 K.

With this spike—forebody configuration the spike tip is confronted with the full force of heating. Heat transfer is a function of temperature difference, heat transfer area and coefficient of convection. There is very little, without increasing vehicle mass considerably, that can be done with the temperature difference or the coefficient. What is left is area. Therefore, the cone-shaped spike tip wetted area is made as small as it is necessary to produce the spike tip shock wave. A further measure is to convey the heat absorbed by the spike tip away. Towards this end the separated recirculating relatively cooler flow following the spike tip, around the spike rod, is used as a heat sink. The heat from the spike tip, made of a heat-resistant material, is conducted through an internal lining of the spike rod, made of a highly conductive material, to the spike rod external surface and from there to the relatively cooler surrounding separated recirculating flow. Additionally, the spike tip could be replaced with a new one after each mission.

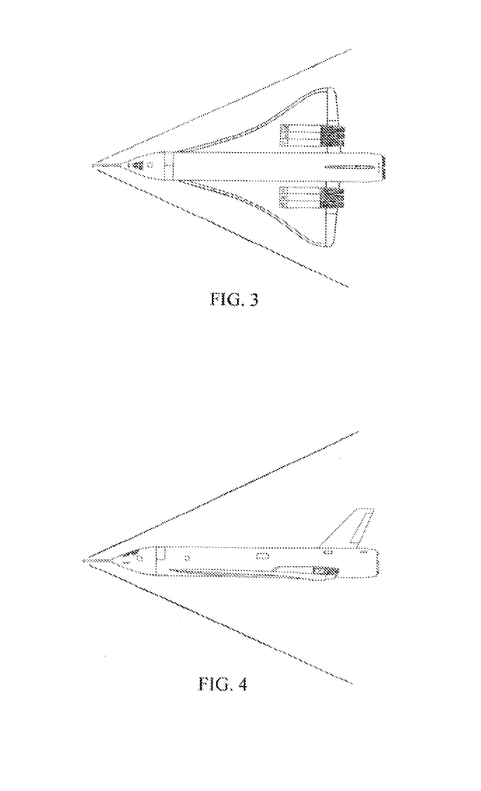

Because the cone-shaped spike tip is small and is followed by a region of separated recirculating flow, shock wave—boundary layer interaction at the spike tip is minimal and, hence, the shock wave emanating from the spike tip is mildly curved. As a consequence, heat due to the spike tip shock wave is dissipated over a much wider area, and away from the vehicle. Furthermore, as the semi-angle of the cone-shaped spike tip is large, the shock angle of the spike tip shock is large-enough so that the spike tip shock wave does not meet the shock wave of the wing, the tail or other protruding parts of the vehicle. Therefore, a shock wave—shock wave interaction with all its adverse effects on flow pressure and temperature levels is avoided. As depicted in FIGS. 3 and 4 the whole of the aerospace vehicle lies within the cone of the shock wave produced by the spike tip. If the additional drag of some phase of the vehicle's flight envelope is worth the extra weight, a telescopic spike could be adopted. Overall, the proposed spike-forebody configuration substantially reduces aerodynamic heating effects in the forebody, the region after the forebody, the wing and tail leading edges and any protruding parts of the hypersonic aerospace vehicle. Therefore, a conventional TPS with the associated mass penalty, and safety, cost, reliability and maintenance drawbacks is avoided.

I claim:

1. An aerospace vehicle travelling through or entering the atmosphere at hypersonic speeds having a conical forebody embodying an upstream facing spike projecting from its stagnation point with a rod-like body of appropriate length and a tip in the shape of a cone. The semi-angle of the conical forebody is much smaller than the semi-angle of the cone-shaped spike tip resulting in a region of separated recirculating flow between the spike tip shock wave and the forebody and a series of expansion waves near the forebody—main body intersection. The whole of the aerospace vehicle lies within the cone of the shock wave produced by the spike tip.
